(19) United States
(12) Patent Application Publication
(10) Pub. No.: US 2020/0221906 A1
(43) Pub. Date: Jul. 16, 2020

(54) POT AND BOWL LID REST AND CONDENSATION HOLDER

(71) Applicant: Steven A. Allamby, Bowie, MD (US)

(72) Inventor: Steven A. Allamby, Bowie, MD (US)

(21) Appl. No.: 16/246,337

(22) Filed: Jan. 11, 2019

(51) Int. Cl. A47J 47/16; A47J 36/06; A47L 19/00

(52) U.S. Cl. CPC A47J 47/16; A47L 19/00; A47J 36/06

(57) ABSTRACT

A disassembleable device amenable to convenient placement on a surface immediately adjacent to a location where at least one pot, pan, or bowl covered with a lid and containing materials is undergoing cooking or heating, the device being adapted to hold plural lids in a position such that any material which has condensed or spattered on the underside of the lids will gravitate into and be collected by the device, and also being adapted to hold any utensils.

### FIELD OF THE INVENTION

The present invention relates, in general, to a lid holder apparatus, in particular to a condensation collection lid holder apparatus.

### BACKGROUND OF THE INVENTION

While cooking or heating items such as, for example, foodstuffs in pots, pans, bowls, and the like, it sometimes proves necessary to cover the latter with lids during the heating or cooking process. Customarily, cover lids for these devices are provided with handles to enable their removal during or after the cooking/heating process. In addition, cooked and/or heated foodstuffs are often transferred to serving bowls which may also be covered with lids. The underside of the lids, however, are typically laden with condensed moisture emanating from the contents of the pot, pan, or bowl, as well as portions of the contents undergoing cooking or heating. It eventually becomes necessary to access the contents of the cooking/heating/serving device, which requires removal of the cover/lid. This requires placement of the latter somewhere in order to free the hands of the operator to perform any necessary function with respect to the contents.

Ordinarily, the lid/covers are placed on an adjacent work surface, which results in any moisture or debris which has condensed or spattered onto the underside of the lid/cover to be deposited on the resting surface, thus creating an unsightly mess. Moreover, if the contents undergoing heating or cooking are foodstuffs, there exists the health risks associated with the retention on the work surface of any food debris deposited thereon from the lid/cover, since it may contain or develop harmful bacteria.

So-called cooking “caddies” are available which are designed to hold covers/lids of heating/cooking or food serving devices; however, these typically can only accommodate a single lid/cover and are not designed to allow run-off and collection of any condensed or spattered moisture or foodstuffs. In addition, the prior art devices suffer from the further disadvantage that they do not enable placement therein of utensils employed in the cooking process.

### SUMMARY OF THE INVENTION

The above-discussed disadvantages associated with the currently available prior art devices are overcome and the objects of the invention are realized by a disassembleable device amenable to convenient placement on a surface immediately adjacent to a location where at least one pot, pan, or bowl covered with a lid and containing materials is undergoing cooking or heating, the device being adapted to hold plural lids, when removed from the pot, pan or bowl, in a position such that any of the materials undergoing cooking or heating which has condensed or spattered on the underside of the lids exposed thereto will gravitate exclusively into and be collected by the device, and also being adapted to hold any utensil employed in the cooking or heating process in a position such that any of the materials undergoing cooking or heating deposited thereon will remain in the device.

### DESCRIPTION OF THE DRAWINGS

FIG. 1 is a perspective top angle view of one embodiment of the invention.

FIG. 2 is a perspective right rear angle view of one embodiment of the invention.

FIG. 3 is a perspective left front angle view of one embodiment of the invention.

FIG. 4 is a perspective right front angle view of one embodiment of the invention.

FIG. 5 is a perspective side view of another embodiment of the invention.

FIG. 6 is a perspective rear view of another embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The device of the invention enables the user thereof the convenience of maintaining a clean, orderly and health risk-free environment while cooking, heating, or serving food stuffs. It is amenable for use by professional and non-professional food preparers and servers to place lids, prevent spills, moisture rings, from cluttering the surrounding work area. The device of the invention is disassembleable for easy cleaning and storage and is capable of holding multiple lids simultaneously in a position in which condensed and spattered material will readily drain into a collection area for easy disposal. Moreover, the device of the invention is capable of holding a cooking/heating utensil.

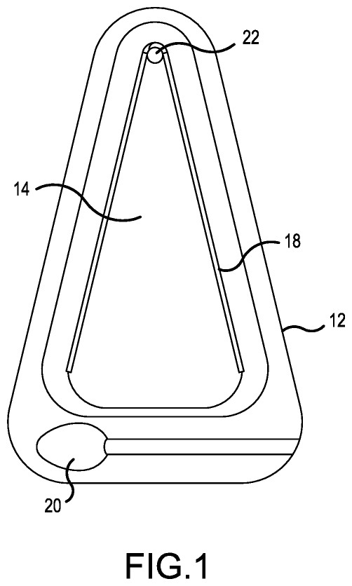

Referring to the drawings, FIG. 1 depicts a top angle view of the preferred triangular base 12 of the device which contains on its upper side an indentation or bowl 14 for the collection of condensed moisture and spattered foodstuffs which drain from lids (not shown) positioned thereover. The outer periphery 16 of the indentation 14 is provided with grooves 18 in which a lid holder (not shown in this view) may be removably positioned. At the base of the triangular element 12, another indentation 20 is provided which is adapted to hold a cooking/heating utensil (not shown). A grooved indentation 22 is provided at the apex of the triangular base element 12 within indentation 14 in which a grooved rod/stand (not shown) may be removably positioned for affixing the lid holder elements (not shown) to the base.

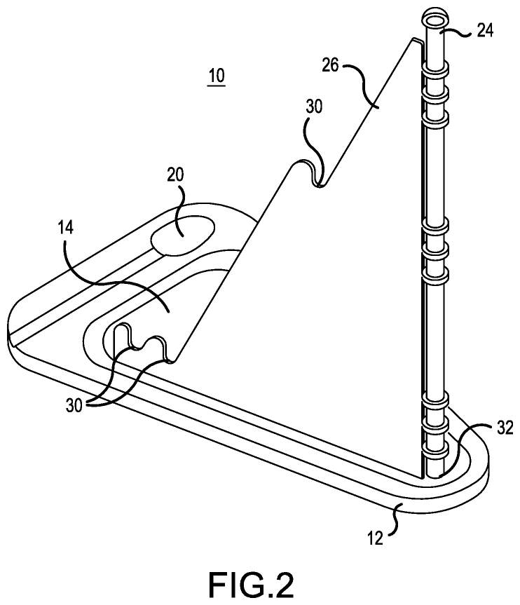

FIG. 2, which depicts a right rear angle view of the device 10 of the invention, shows base 12, indentations 14 and 20, removable rod/stand 24 and one of the lid holder stands 26. Lid stand 26 is provided with notches 30 for accommodating lids/covers positioned thereon. Stand 26 is provided with edges which are removably fixable into groove 18 in the base 12 and the groove 32 in rod/stand 24. Also shown is indentation 20 for holding any cooking/heating utensil.

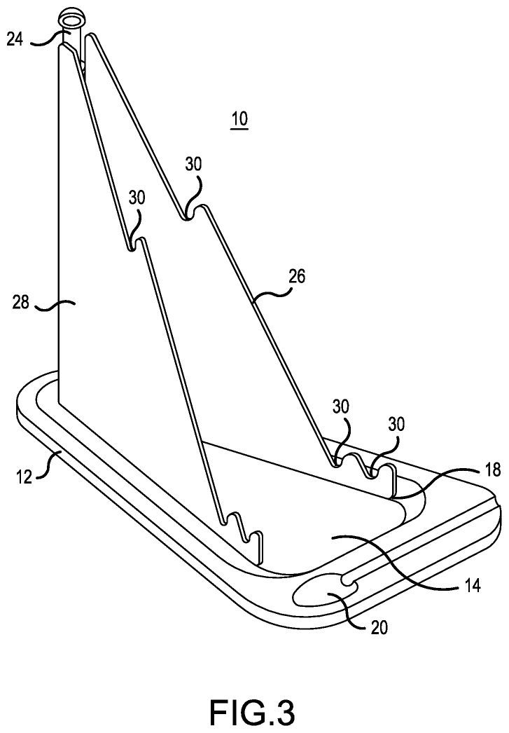

FIG. 3, which depicts a left front angle view of the device 10 of the invention, shows base 12, indentations 14 and 20, removable rod/stand 24, and lid holder stands 26 and 28. Identically to lid stand 26, lid stand 28 is provided with edges which are removably fixable into groove 18 in the base 12 and the groove 32 provided in rod/stand 24. Also identically to lid stand 26, lid stand 28 is provided with notches 30, adapted to cooperate with the notches in lid stand 26 for accommodating lids/covers positioned thereon.

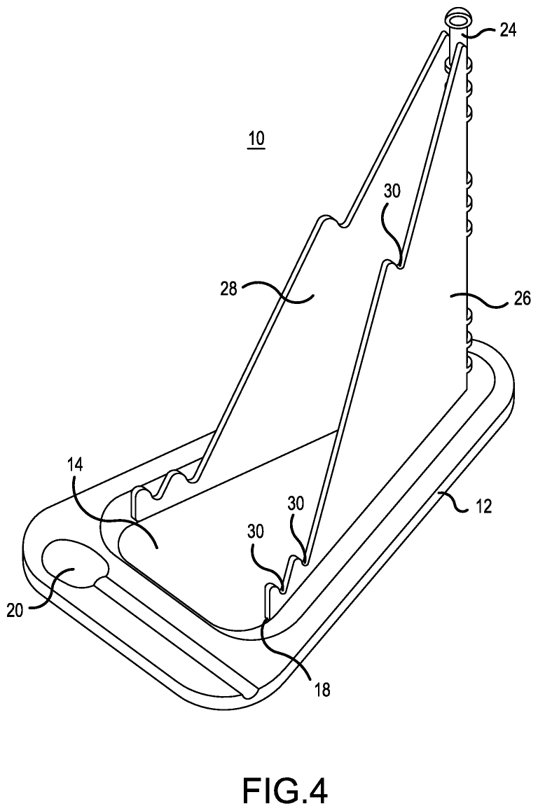

FIG. 4, which depicts a right front angle view of the device 10 of the invention, shows base 12, indentations 14 and 20, removable rod/stand 24 removably fixed into base 12, and lid holder stands 26 and 28 removably fixed into groove 18 in the base 12 and the groove 32 in rod/stand 24. Also shown is indentation 20 for holding any cooking/heating utensil.

The preferred device 10 of the invention preferably has a triangular bowl shaped base 12. The lid stands 26 and 28 are secured to the base 12 by being inserted into groove 18 in the base and into grooved rod/stand 24. The indentation 14 in base 12 serves the function of catching condensation or other residue which gravitationally falls thereinto from lids/covers (not shown) positioned therein on lid stands 26 and 28. Indentation 20 provides a resting place for a cooking utensil. The device 10 when assembled has multiple levels and notches 30 to accommodate multiple lids, tops and covers of varying shapes and sizes at the same time.

It will be understood by those skilled in the art that the stand/rod 24 may conform to any convenient shape or size suitable for housing grooves 32 capable of supporting holder stands 26 and 28.

Although, the device of the invention has been shown comprising a single utensil holder 20, it will be understood by those skilled in the art that additional indentations may be included in base 12 for holding multiple utensils without departing from the spirit and scope of the invention.

The device 10 of the invention is easily dismantled by simply disengaging the lid stands 26 and 28 from the grooves 18 in the base 12 and the grooves 32 in rod/stand 24. Rod/stand 24 is also easily removed by disengagement from the groove in base 12.

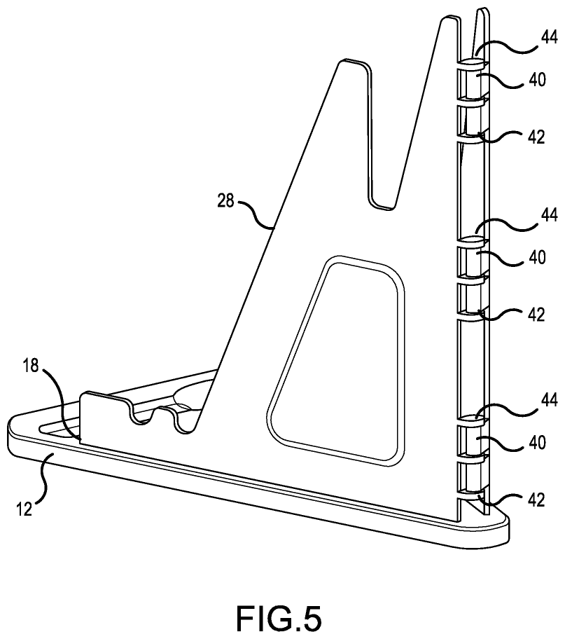

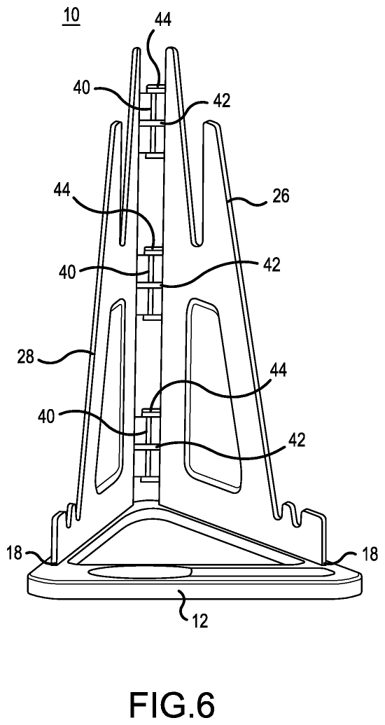

In a preferred embodiment of the invention, one or more hinge mechanisms are substituted for the rod/stand 24 for the purpose of joining and stabilizing the holder stands 26 and 28 at the apex of the triangular base 12. Referring to FIGS. 5 and 6, read in conjunction with FIGS. 1-4, holder stands 26 and 28 are removably fixated/supported in the grooves 18 of base 12 as described above. Instead of a rod/stand 24, complementary, one or more interconnecting hinge mechanisms 40 and 42 are provided at the rear edges of the holder stands 26 and 28, respectively, which, when joined and fixed together with hinge pins 44, stabilize the holder stands and prevent separation thereof, but permit their easy removal from base 12. It will be understood by those skilled in the art that any number of hinge mechanisms may be employed. For example, a single pair of complementary, interconnecting hinge mechanisms 40 and 42 may affixed to the rear edges of holder stands 26 and 28, respectively; however, it is preferred to utilize three hinge mechanisms spaced evenly along the rear edges of the holder stands, an arrangement which provides maximum stabilization thereof at minimal cost.

The device of the invention may be provided ready for use in assembled form or in as a kit containing its component, packaged with instructions for its assembly into a usable device.

It will be understood by those skilled in the art that the device of the invention may be constructed from any suitable non-toxic material, preferably one which will withstand machine washing such as, for example, plastic, glass, stone, stainless steel, aluminum, and mixtures thereof

What is claimed is:

1. A holder for multiple lids or covers of cooking or heating vessels, and for at least one utensil employed with the cooking or heating vessel comprising a generally triangular planar base having a top surface; a generally triangular first indentation disposed within the top surface of the base, said triangular indentation being substantially equiangular with the generally triangular base; coextensive grooves provided in the outer periphery of two sides of the generally triangular first indentation which intersect at a second indentation provided substantially at the apex of the said two sides of the first triangular indentation; a third indentation disposed in the top surface of the base adapted to hold said at least one utensil; a rod suitable for positioning in said third indentation and being provided with two parallel grooves extending substantially the length of said rod; and two generally triangular stands, a first side of each of which is provided with an edge which is firmly fixable in but removable from said two grooves provided in said first indentation, a second side of each generally triangular stand being provided with an edge which is firmly fixable in but removable from said two parallel grooves in said rod, and a third side of each generally triangular stand being provided with notches aligned with each other to hold said multiple lids or covers in positions such that any material undergoing cooking or heating in said vessels that has condensed or spattered onto the lids or covers will gravitationally drain into said first indentation.

2. The holder of claim 1 in assembled form.

3. The holder of claim 1, disassembled and packaged in kit form with instructions for assembly thereof.

4. The holder of claim 1 wherein said third indentation for holding said at least one utensil is positioned opposite of the apex of the generally triangular base in which said second indentation is positioned.

5. The holder of claim 1, the elements of which are constructed of plastic, glass, stone, stainless steel, aluminum, or mixtures thereof.

6. A disassembleable holder for multiple lids or covers of cooking or heating vessels, and for at least one utensil employed with the cooking or heating vessel comprising a generally triangular planar base having a top surface; a generally triangular first indentation disposed within the top surface of the base, said triangular indentation being substantially equiangular with the generally triangular base; coextensive grooves provided in the outer periphery of two sides of the generally triangular first indentation which extend along a substantial length thereof; two generally triangular stands, a first side of each of which is provided with an edge which is firmly fixable in but removable from said two grooves provided in said first indentation, a second side of each generally triangular stand being provided with at least one hinge mechanism, wherein the at least one hinge mechanism on one triangular stand is complementarily interconnectable with the at least one hinge mechanism on the other triangular stand by a hinge pin, and a third side of each generally triangular stand being provided with notches aligned with each other to hold said multiple lids or covers in positions such that any material undergoing cooking or heating in said vessels that has condensed or spattered onto the lids or covers will gravitationally drain into said first indentation.

7. The holder of claim 6 in assembled form.

8. The holder of claim 6, disassembled and packaged in kit form with instructions for assembly thereof.

9. The holder of claim 6 wherein said third indentation for holding said at least one utensil is positioned opposite of the apex of the generally triangular base in which said second indentation is positioned.

10. The holder of claim 6, the elements of which are constructed of plastic, glass, stone, stainless steel, aluminum, or mixtures thereof.
